(19) United States
(12) Patent Application Publication
(10) Pub. No.: US 2024/0248978 A1
(43) Pub. Date: Jul. 25, 2024

(54) ELECTRONIC COMPONENT AUTHENTICATION SYSTEM

(71) Applicant: Adaptix Ltd, Begbroke (GB)

(72) Inventors: Mark Evans, North Leigh (GB); David Keith Bowen, Warwick (GB)

(21) Appl. No.: 18/582,283

(22) Filed: Feb. 20, 2024

Related U.S. Application Data
(63) Continuation of application No. PCT/GB2022/052136, filed on Aug. 17, 2022.

(30) Foreign Application Priority Data
Aug. 18, 2021 (GB) 2111847.6

(51) Int. Cl. G06F 21/44; G06T 7/00; G06T 7/62; G06V 30/10

(52) U.S. Cl. CPC G06F 21/44; G06T 7/0002; G06T 7/62; G06V 30/10; G06T 2207/10116

(57) ABSTRACT

Methods for analysis of silicon chips and other electrical components are presently slow, often requiring much human intervention. An electronic component authentication system is provided comprising apparatus to obtain images, of an electronic component to be authenticated, in the visible spectrum, and the infrared spectrum, the system further comprising apparatus to obtain X-ray images of the electronic component and to process at least some of those X-ray images to provide a 3D tomosynthesis image of the electronic component, the system further comprising a processor configured to analyse the obtained images to ascertain criteria relating to the electronic component and authenticate the ascertained criteria against a set of known criteria.

### RELATED APPLICATIONS

This application claims the benefit under 35 U.S.C. § 120, and is a continuation, of co-pending International Application PCT/GB2022/052136, filed Aug. 17, 2022 and designating the US, which claims priority to GB Application 2111847.6, filed Aug. 18, 2021, such GB Applications also being claimed priority to under 35 U.S.C. § 119. These GB and International applications are incorporated by reference herein in their entireties.

### FIELD

The present invention relates generally to an electronic component authentication system and a method of authenticating an electronic component, and finds particular, although not exclusive, utility in identifying counterfeit electronic components.

### BACKGROUND

Counterfeit electronic components, such as “silicon chips” can be inadvertently included in electronic systems such as defibrillators, airport landing lights, intravenous (IV) drip machines, and braking systems for high-speed trains. Accordingly, the risk of counterfeit chips can range from an inconvenience, to injury, or loss of life.

Presently, counterfeit chips may be identified by manual labour using tweezers, a physical measuring tool and a microscope, 2D X-ray imaging, electrical testing or destructive analysis. Confocal-Scanning Acoustic Microscopy (C-SAM) is also a known method of identifying counterfeit chips.

However, all of these methods are time-consuming and can therefore only be undertaken on a relatively small sample. A manufacturer of products requiring the inclusion of such chips will be buying many thousands at a time making it very difficult to weed-out the counterfeits.

### SUMMARY

It is therefore desirable to be able analyse greater numbers of electronic components, such as silicon chips, more quickly, and less labour intensively.

In one aspect, the invention provides an electronic component authentication system comprising apparatus to obtain images, of an electronic component to be authenticated, in the visible spectrum, and the infrared spectrum, the system further comprising apparatus to obtain X-ray images of the electronic component and to process at least some of those X-ray images to provide a 3D tomosynthesis image of the electronic component, the system further comprising a processor configured to analyse the obtained images to ascertain criteria relating to the electronic component and authenticate the ascertained criteria against a set of known criteria.

The imaging may be regarded as multi-spectral.

In some examples, the electronic component authentication system further comprises an apparatus to obtain images of the electronic component in the ultraviolet spectrum.

The apparatus to obtain each of the visible, infrared and ultraviolet images may be provided by a single component. Alternatively, the apparatus to obtain each of the visible, infrared and ultraviolet images may be provided by one or more separate components, each configured to operate in one or more of the visible, infrared and ultraviolet spectrum.

In some examples, the apparatus to obtain images may be one or more cameras. For example, the apparatus to obtain images may include a camera with one or more imaging sensors configured to receive one or more wavelength ranges of ultraviolet, visible and infrared light and distinguish said wavelengths in an image. Alternatively, or additionally, the apparatus to obtain images may comprise a plurality of cameras, each configured to receive and distinguish at least one of the wavelength ranges of ultraviolet, visible and infrared light and convert said at least one wavelength range into an image.

The apparatus for obtaining X-ray images may comprise an “FPS”—flat panel source. The FPS may include a set of hardware and software components which may provide a controllable array of X-ray sources, an integrated high voltage supply, control electronics and firmware, external control software for the device, essential calibration systems, and software to convert X-ray images collected with the device into usable images for an operator and/or a computer processor.

The FPS may include an X-ray generator which is a controllable array of X-ray sources. In use, the X-rays may pass through the component and form an image on the detector. The detector may be responsive to X-rays of the energy produced by the source, and may have an appropriate spatial resolution for the detail which is expected. The detector may be capable of collecting a series of images in quick succession. A rapid dynamic detector may require precisely timed control and the ability to offload the collected data at an appropriate rate.

In some examples, the apparatus for obtaining x-ray images may comprise one or more individual x-ray sources configured to emulate a flat panel source with a controllable array of x-ray sources. For example, one or more x-ray sources may be provided and configured to be moved in a two-dimensional plane perpendicular to a direction of x-rays emitted by the sources to capture a series of x-ray images. The x-ray images collected with the apparatus may be converted and/or combined using software to provide three-dimensional images. More specifically, the one or more x-ray sources may be provided and moved in a raster, snake or spiral scanning pattern.

In other examples, the apparatus for obtaining x-ray images may comprise one or more x-ray detectors configured to be moved in a two-dimensional plane, perpendicular to a direction in which one or more x-ray sources emit x-rays, to capture a series of x-ray images. The x-ray images collected with the apparatus may be converted and/or combined using software to provide three-dimensional images. The X-ray generator and detector may be held in alignment by arms. These serve a number of purposes, including supporting the mass of the electronic components to be authenticated, providing positioning to achieve alignment and a particular source-image distance, and providing separation between the X-ray source and the electronic components to be authenticated.

The apparatus for obtaining x-ray images may comprise an upper arm, a lower arm, and a connecting member for maintaining the position of the upper and lower arms relative to one another. One of the upper and lower arms may include at least one X-ray source whilst the other of the upper and lower arms may include an X-ray detector. The apparatus for obtaining x-ray images may further comprise movement means for moving the apparatus relative to the electronic components to be authenticated.

A low voltage power supply may be provided for powering the X-ray generator, its electronics, to operate the controls for the individual X-ray sources (such as solenoids for diverting beams of electrons between X-ray producing targets and electron absorbing material), and to power an integrated source of high voltages to operate the X-ray sources (to produce the electrons).

In use, the X-ray generator may produce a number of X-ray pulses, of known intensity and duration, from known positions, in a defined sequence. After detection by the detector a set of images representing slices through the component may be produced by the processor.

The known set of criteria may be provided by the (OEM) manufacturers of the original components. Alternatively, or additionally, the known criteria may be ascertained by imaging and analysing original components. A database of criteria may be created or obtained for use in such comparisons. The system may be configured to store all images obtained in the database.

An aim of the invention is to provide an automated system such that a greater number of components may be analysed with less human involvement, to thereby reduce costs. Accordingly, computer processing may be employed to analyse the obtained images using such known techniques of image processing. The images may be analysed for reflectivity. Various criteria may be analysed as will be explained herein.

3D digital tomosynthesis image processing will use critical geometry as part of the reconstruction process (which preserves all the dimensions of the subject) to automatically size components. The processor may be configured to analyse the obtained images to determine a dimension of the electronic component. This may be effected by the use of image processing software identifying features such as objects in an image having a boundary defined by a change in colour (frequency), or contrast, and then determining the distance between opposite sides of this boundary. Such image processing and subsequent measurement determinations may be automated. Alternatively, or additionally, human involvement may occur to assist in such identification of features and measurement thereof.

Alternatively, or additionally, an optical microscope may be provided and used to determine dimensions of the component.

Moreover, the system is configured to form image reconstruction which are defined by measurable, or known, parameters such as one or more of X-ray source-to component distance, X-ray source to X-ray detector distance, X-ray detector pixel dimensions, and component height. These distances and dimensions are defined, in use, to a certain accuracy, thus enabling the image reconstruction to be accurate in three dimensions with no distortions. Accordingly, it may be used for accurate dimensional measurement, metrology of component spacings or breaks, and the degree to which the internal structure matches the reference component or data.

An X-ray opaque graticule may also be provided for dimensional determination and/or identification of counterfeit components.

The system may be configured to determine the dimensions of gaps between adjacent connectors, the angles between the linear length of adjacent connectors, and the continuity of connectors. This may be effected by similar methods to those described herein with respect to the determination of dimensions of the component.

The system may be configured to analyse lead frames provided with silicon chips. The analysis may determine the dimensions of gaps between adjacent connection points and leads, the angles between adjacent connection points, and the continuity of the connection points. This may be effected by similar methods to those described herein.

The processor may be configured to compare the obtained infrared and/or ultraviolet images with visible spectrum images to determine one or more features indicative of counterfeiting. For example, features indicative of counterfeiting include ascertaining the presence of oxides and/or lead in the electronic component, such as the connectors. For instance, tin oxide is transparent in the visible spectrum, but absorbs light in the infrared and ultra-violet spectra. Accordingly, a comparison of images obtained in various spectra may be used to identify the presence, or otherwise, of tin oxide on, for instance, electrical connectors. Alternatively, or additionally, such a comparison may comprise a comparison of the relative reflectivity of parts of the images. For instance, a relatively thick (c. 20 microns) coating of tin oxide may be visible using infrared imaging with a wavelength of approximately greater than 14 micrometers, preferably 17 micrometers, or ultraviolet imaging with a wavelength of approximately 300 nm. Such a thickness of tin oxide may be distinguished from a “native” (i.e., naturally acquired) layer of tin oxide which would only be approximately 10 nm, which would have different reflectivity characteristics.

A reflectivity indicating a thickness more than or equal to 1 micrometers may be considered to be non-native, and therefore applied by a manufacturing process.

Similarly, the presence and/or location of lead may be determined.

The processor may be configured to provide optical character recognition of the obtained images in the various spectra to provide data equivalent to any text located on the electronic component, the processor configured to use the data for determining the authenticity of the electronic component. For instance, the text in any location on the component may be compared to text from legitimate components, or compared to the text obtained from other components, in a batch of similar components, to identify if it is different from those other components in the batch, to thus determine the authenticity of the component.

Some counterfeit electrical components are often subjected to so-called “black-topping”, whereby a thin layer of material is applied to surfaces on the component to cover the original part numbers and details. This is then re-printed with false markings in order to purposefully present the part as something else. Alternatively, the surface of the component is abraded to remove text printed thereon. New text may be printed in place. The new text may be imaged and compared to known OEM supplier criteria to identify counterfeits, or compared to the text obtained from other components, in a batch of similar components, to identify if it is different from those other components in the batch, to thus determine the authenticity of the component.

The system may further comprise means for determining the reflectivity of the component in various spectra, wherein the processor is configured to use the reflectivity data for determining the authenticity of the electronic component. This may include the determination of the reflectivity of the top of a component to identify if it has been abraded and/or “black-topped”, and thus potentially be a counterfeit product. This may also include the determination of the presence and/or thickness of oxides present, for example on connectors in the component.

The reflectivity (or reflectance) may be determined by a reflectance spectrometer. Alternatively, or additionally it may be possible to use a sensor to obtain a colour photograph (only in infrared).

The reflectivity, or colour, may be compared to known OEM supplier criteria to identify counterfeits, or compared to the reflectance, or colour, data obtained from other components, in a batch of similar components, to identify if it is different from those other components in the batch, to thus determine the authenticity of the component.

This imaging may also be used to reveal any text which may be included within the casing of the component. By using image processing, this text may be identified by the processor and compared to known OEM supplier criteria to identify counterfeits. Also, such internal text can be cross-referenced with the imaged external text to ascertain if such a component is supposed to have such internal and external text as identified.

The processor may be configured to compare the images, obtained at various spectra, of one electrical component, with those obtained, at various spectra, from another electrical component, for use in authenticating either electronic component.

This may relate to the identification and comparison of text including fonts, trademarks/logos, constituent materials, surface textures, arrangements of components, numbers of components, colours of components, size of components, shape of components, and so on.

The processor may be configured to analyse the obtained images to investigate a cavity formed in the electrical component for use in authenticating the electronic component.

For instance, cavities provided in the surface of silicon chips are often included to provide an indication of the location of pin one. If the surface of the chip has been abraded to remove text, the cavity shape and or size may be different to that of a reference cavity. Alternatively, or additionally, the cavity on a counterfeit chip may not be clean, regular, or smooth due to inferior manufacturing methods. Image processing software may be used to identify the shape, size or cleanliness of such cavities. Alternatively, or additionally, the image of the cavity in the component may be superimposed over, or compared with, the image of a cavity from a bona fide component and/or with other components in a batch, and image processing software used to identify differences therebetween with an aim to identify a counterfeit product.

The processor may be configured to analyse the obtained X-ray images of the electrical component and determine the presence, or otherwise, of lead or other metals for use in authenticating either electronic component. This determination may be provided by means of spectrographic analysis. For instance, the absorption characteristics varies from metal to metal and thus it may be possible to determine which metal is present. The presence, or otherwise, of a certain metal may be checked against known criteria for the component being tested to aid determination of counterfeit components.

The processor may be configured to analyse the obtained X-ray images of the electrical component and determine the continuity of connectors and wire-bonds, determine their layout and any variations in angles and/or gaps between connectors (possibly indicating they have been recycled) and so on. For instance, if wire bonds do not link the silicon die to the relevant leg on the frame, then the device may not function correctly. Solder balls may also be identifiable in the images. The location, and/or size, and/or density of the balls may be compared with criteria to aid determination of counterfeit products.

Furthermore, the X-ray imaging may be undertaken as a dual-energy image acquisition to acquire suitable 3D X-ray images of the plastic at relatively low energy (such as ˜30 kV) to detect cracks, delamination or voids in the plastic casing, and also imaging the component at relatively high-energy (such as ˜70 kV) to acquire inspection images of metals comprised in the component. These two image outputs will be combined to give a clear inspection of both the plastic casing and metal products to further evaluate the component.

In some examples, the apparatus to obtain X-ray images of the electronic component comprises a flat panel source that includes a controllable array of X-ray sources.

In some examples, the apparatus to obtain X-ray images of the electronic component comprises one or more x-ray sources arranged to be moved in a two-dimensional plane perpendicular to a direction of x-rays emitted by said sources to capture a series of x-ray images.

In a second aspect, the invention provides a method of authenticating an electronic component comprising the steps of: providing an electronic component authentication system according to the first aspect; providing an electronic component;

obtaining images of the electronic component to be authenticated, in the visible spectrum, the infrared spectrum, and the ultraviolet spectrum, obtaining X-ray images of the electronic component; processing at least some of those X-ray images to provide a 3D tomosynthesis image of the electronic component; analysing the obtained images to ascertain criteria relating to the electronic component; comparing the ascertained criteria against a set of known criteria to provide information as to the authenticity of the electronic component.

A processor may be configured to provide the analysis, such as analysing the obtained images.

The analysis of the images may include comparing an x-ray image taken at one height through the component with that of an x-ray image taken at another height through the component. For instance, the relative focus of a portion of one image with respect to that of the same portion of a different image.

The analysis of the images may include comparing the focus of a first portion of an x-ray image taken at one height through the component with that of a second portion of the x-ray image. In some examples, the focus of a first portion of an x-ray image taken at one height through the component may be compared with that of a second portion of the x-ray image to determine whether the contacts of an integrated circuit or chip are level relative to one another using a single x-ray image. Contacts of an integrated circuit or chip are electrically conductive and may comprise pins, legs, balls, pads, wire bonds, wire bond terminations, or wires forming part of a connector.

The analysis of the images may determine dimensions of the electronic component. The analysis may compare the obtained infrared and/or ultraviolet images with visible spectrum images thus ascertaining the presence of oxides on electrical connectors in the electronic component. The analysis may provide optical character recognition of the obtained images in the visible spectrum thus providing data equivalent to any text located on the electronic component, wherein the method may further comprise the step of processing the data and determining the authenticity of the electronic component.

The method may comprise the step of comparing the images obtained at various spectra of one electrical component with those obtained at various spectra from another electrical component for authenticating either electronic component. The method may comprise the step of obtaining the reflectivity of the component in various spectra, such as infrared and/or ultraviolet for authenticating either electronic component.

The method may comprise the step of analysing the obtained images to investigate a cavity formed in the electrical component for use in authenticating the electronic component.

The method may comprise the step of analysing the obtained images of the electrical component and determining the presence, or otherwise, of lead for use in authenticating the electronic component.

It is expected that at least some, if not all, of the methods may be automated to thereby increase the speed of the analysis of components.

In another aspect there is provided an electronic component authentication system comprising apparatus for obtaining images, of an electronic component to be authenticated, in the visible spectrum, the infrared spectrum, and the ultraviolet spectrum, the system further comprising apparatus for obtaining X-ray images of the electronic component and for processing at least some of those X-ray images to provide a 3D tomosynthesis image of the electronic component, the system further comprising a processor configured to analyse the obtained images to ascertain criteria relating to the electronic component for use in authenticating it against a set of known criteria.

In another aspect there is provided a method of authenticating an electronic component comprising the steps of: providing an electronic component authentication system described herein; providing an electronic component; obtaining images of the component to be authenticated, in the visible spectrum, the infrared spectrum, and the ultraviolet spectrum, obtaining X-ray images of the electronic component; processing at least some of those X-ray images to provide a 3D tomosynthesis image of the electronic component; analysing the obtained images to ascertain criteria relating to the electronic component; comparing the ascertained criteria against a set of known criteria to provide information as to the authenticity of the electronic component.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is an X-ray image of a silicon chip;

FIG. 2 is a close-up X-ray image of a silicon chip;

FIG. 3 is an X-ray image of another silicon chip;

FIGS. 4 and 5 are X-ray images of the chip of FIG. 3; and

FIGS. 6 to 8 are a series of X-ray images of a further silicon chip.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

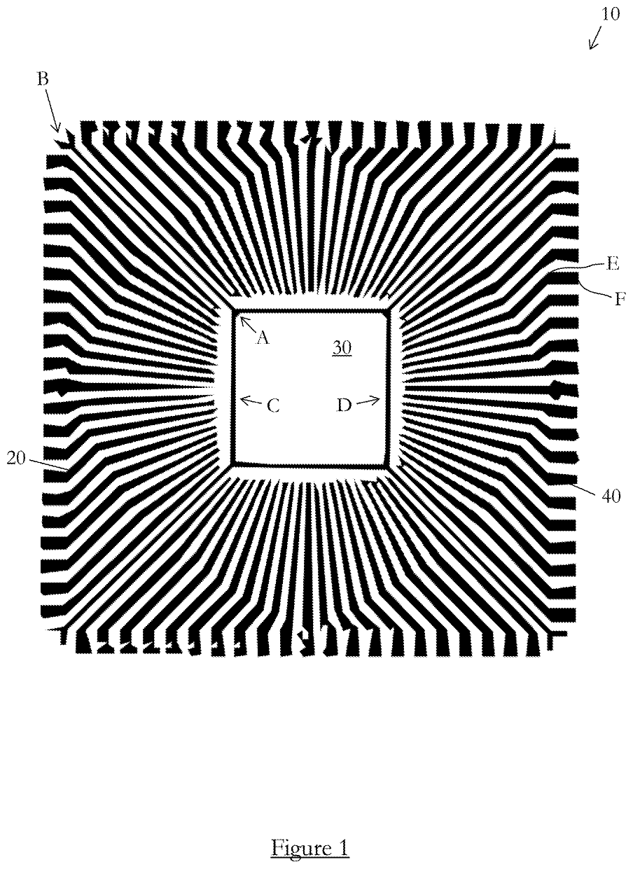

Using 3D tomosynthesis X-ray imaging of a silicon chip, a series of images is produced each at a different level, or height, through the chip. An example of one such “slice” image is shown in FIG. 1. It may be understood that each x-ray image of the series of images is an image taken at a specific depth into the chip or integrated circuit, otherwise referred to as a level or height through the chip. The series of images may have a frame of reference. In some examples, the frame of reference may be defined by a surface, or contacts, of the chip or integrated circuit. Each image may depict a plane parallel to the frame of reference. The level or height through the chip may otherwise be referred to as a depth into the chip.

The chip 10 is seen to include the die 30 (comprising the transistors) in the centre of the image surrounded by legs 20 which lead away from the die to connection points, known as “pins” 40 on the periphery of the chip.

The legs 20 are clearly continuous from the die 30 to the pins 40, thus ensuring good connectivity.

Image processing software is able to determine the distance between various objects on the chip 10, such as the width of the die 30 between points C and D; the diagonal length from a corner of the die 30 to the outside corner of the arranged legs 20, between points A and B; and the width of a pin 40 between points E and F. It will be appreciated that other dimensions are determinable.

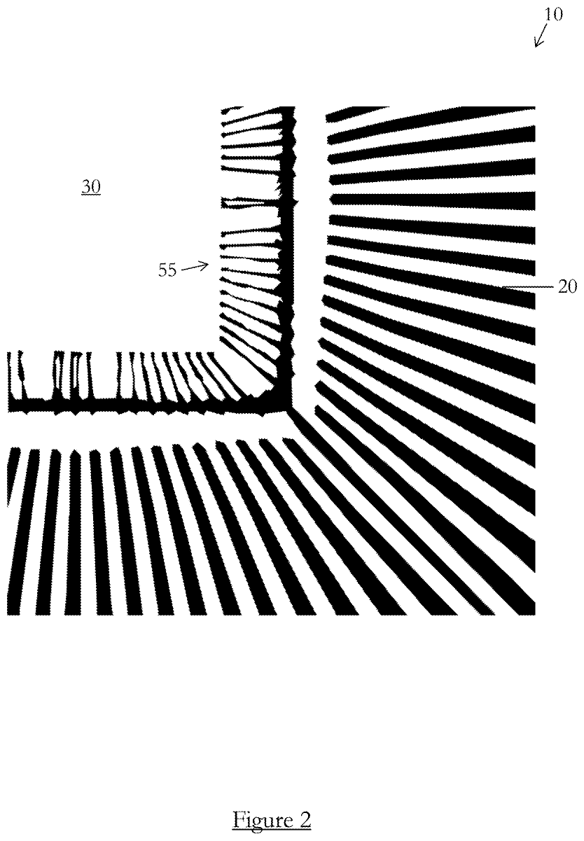

The X-ray image may be interrogated at a finer focus such that the details of the wire bonds 55 are visible as shown in FIG. 2. Their shape and length may be visually checked for continuity and any other apparent defects. Likewise, the shape of the dies may be determined as this also may be used to identify counterfeit components.

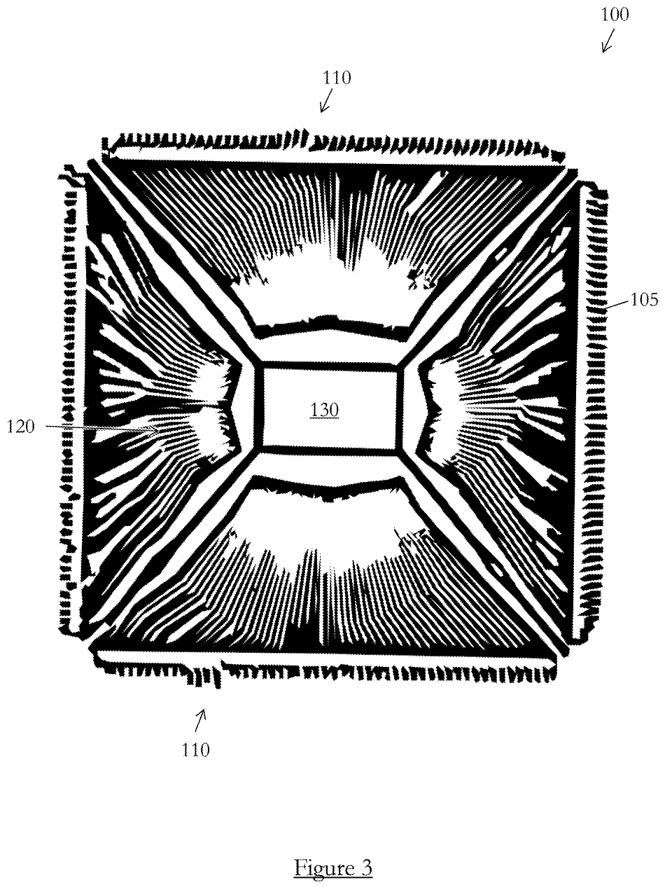

By contrast, an X-ray image of a counterfeit chip 100 is shown in FIG. 3. Some of the pins 110 are clearly seen to be misaligned and out of place with respect to the other pins 105. Moreover, some of the legs 120 are clearly truncated and discontinuous between the die 130 and the pins 105.

FIG. 4 shows one slice of a 3D tomosynthesis X-ray image taken through the same chip as shown in FIG. 3, but at a different height compared to a reference datum, such as the back of the chip. The pins 130 on the left-hand side of the chip are in focus, whereas the pins 140 on the right-hand side are out of focus.

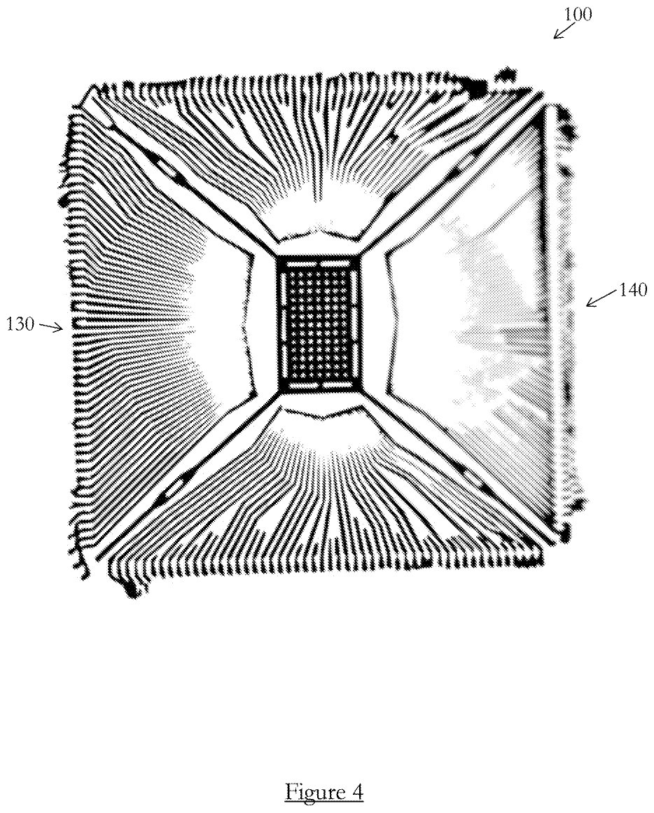

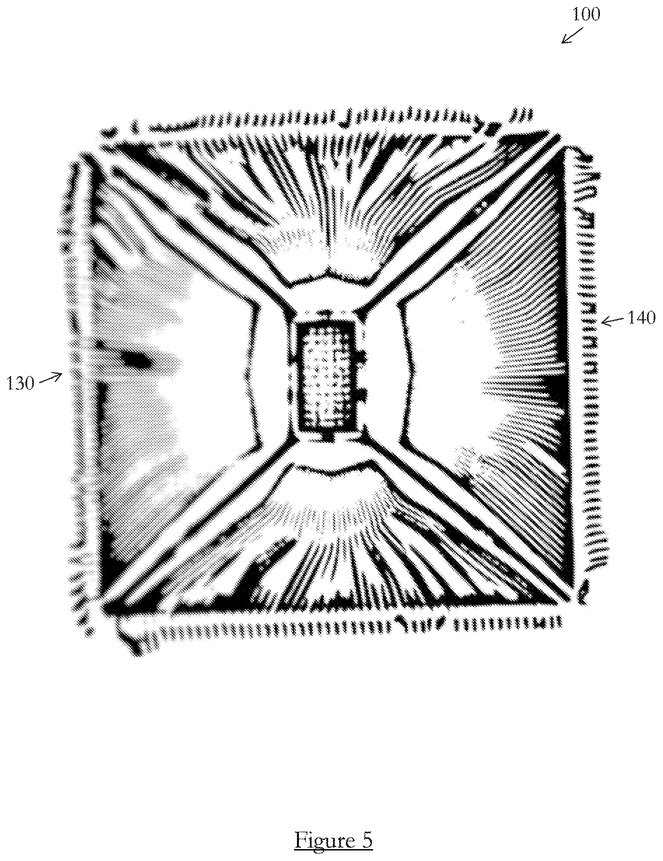

The next slice view (which may be immediately adjacent the slice shown in FIG. 4, or could be a few slices away) is shown in FIG. 5. In this view, the pins 130 on the left-hand side of the chip are out of focus, whereas the pins 140 on the right-hand side are in focus.

These two Figures indicate that the pins are not formed such that all the pins are level with one another relative to a datum. In other words, the ends of the pins 130, 140 which would be soldered onto a substrate, such as a PCB, in use, do not lie all lie in the same plane. Accordingly, it would be difficult, if not impossible, to connect all the pins in use. Furthermore, it is indicative of a counterfeit product, or at least, a faulty chip.

The system may be configured to determine the location of the pins through image analysis and comparison of the various image slices.

FIGS. 6 to 8 show a sequence of slices through a chip 200, each slice having a different height compared to a reference datum, such as the back of the chip 200.

FIG. 6 shows that the legs 210, 220 (in the top right and bottom left-hand corners) are in focus, whereas the legs 230, 240 (in the top left and bottom right-hand corners) are out of focus.

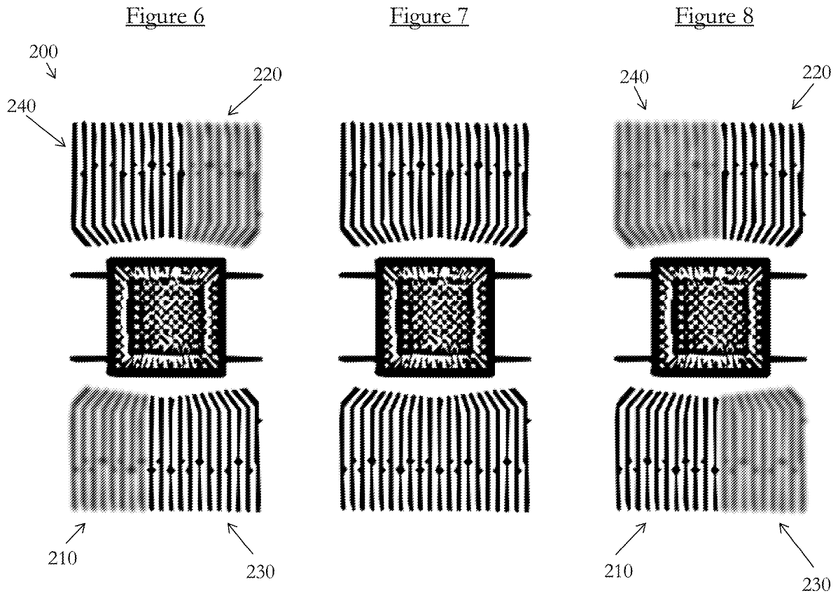

The next slice view (which may be immediately adjacent the slice shown in FIG. 6, or could be a few slices away) is shown in FIG. 7. In this view, all 4 corners of the chip are equally in focus.

However, when the next slice view is viewed in FIG. 8, it is seen how this time the legs 210, 220 (in the top right and bottom left-hand corners) are out of focus, whereas the legs 230, 240 (in the top left and bottom right-hand corners) are in focus. This view may be immediately adjacent the slice shown in FIG. 7, or could be a few slices away.

The overall sequence indicates that the chip 200 is slightly twisted or bent. If it was not twisted or bent, the connectors would all be shown in focus on the same slice view, and all shown out of focus on a different slice view. There would not be any views where only some of the legs are in focus and others are out of focus.

With regard to the use of the term “out of focus” it should be explained that the X-ray imaging method may result in a finite number of individual slices. However, each slice may include portions of the imaged object which are not in the relevant slice, but are in front of, and/or behind the relevant slice (i.e., having another z value than the actual slice). It is these potions which appear out of focus. It is only the portions of the object which are actually in the plane of the slice which appear “in focus”. This is why, ‘out of focus’ portions of the image may be compared with ‘in focus’ portions in the same slice image to determine that the ‘out of focus’ portions are at a different height compared to the datum (or have a different z value), than those of the ‘in focus’ portions and thus may indicate a twisted or bent, or otherwise malformed component.

Image processing software may be employed to determine the focus of various regions or components of the chip. Alternatively, or additionally, human operators may be employed to review the images to determine counterfeit or simply badly manufactured, chips.

1. An electronic component authentication system comprising apparatus to obtain images, of an electronic component to be authenticated, in the visible spectrum, and the infrared spectrum, the system further comprising apparatus to obtain X-ray images of the electronic component and to process at least some of those X-ray images to provide a 3D tomosynthesis image of the electronic component, the system further comprising a processor configured to analyse the obtained images to ascertain criteria relating to the electronic component and authenticate the ascertained criteria against a set of known criteria.

2. The electronic component authentication system of claim 1, further comprising an apparatus to obtain images of the electronic component in the ultraviolet spectrum.

3. The system of claim 1, wherein the processor is configured to analyse the obtained images to determine a dimension of the electronic component.

4. The system of claim 1, wherein the processor is configured to compare the obtained infrared and/or ultraviolet images with visible spectrum images to ascertain the presence of oxides on electrical connectors in the electronic component.

5. The system of claim 1, wherein the processor is configured to provide optical character recognition of the obtained images to provide data equivalent to any text located on the electronic component, the processor configured to use the data for determining the authenticity of the electronic component.

6. The system of claim 1, further comprising a sensor for determining the reflectivity of the component in various spectra, wherein the processor is configured to use the reflectivity data for determining the authenticity of the electronic component.

7. The system of claim 1, wherein the processor is configured to compare the images obtained at various spectra of one electrical component with those obtained at various spectra from another electrical component for use in authenticating either electronic component.

8. The system of claim 1, wherein the processor is configured to analyse the obtained images to investigate a cavity formed in the electrical component for use in authenticating the electronic component.

9. The system of claim 1, wherein the processor is configured to analyse the obtained X-ray images of the electrical component and determine the presence, or otherwise, of lead for use in authenticating either electronic component.

10. The system of a claim 1, wherein the apparatus to obtain X-ray images of the electronic component comprises a flat panel source that includes a controllable array of X-ray sources.

11. The system of claim 1, wherein the apparatus to obtain X-ray images of the electronic component comprises one or more x-ray sources arranged to be moved in a two-dimensional plane perpendicular to a direction of x-rays emitted by said sources to capture a series of x-ray images.

12. A method of authenticating an electronic component comprising the steps of: providing an electronic component authentication system apparatus to obtain images, of an electronic component to be authenticated, in the visible spectrum, and the infrared spectrum, the system further comprising apparatus to obtain X-ray images of the electronic component and to process at least some of those X-ray images to provide a 3D tomosynthesis image of the electronic component, the system further comprising a processor configured to analyse the obtained images to ascertain criteria relating to the electronic component and authenticate the ascertained criteria against a set of known criteria; providing an electronic component; obtaining images of the component to be authenticated, in the visible spectrum, the infrared spectrum, and the ultraviolet spectrum, obtaining X-ray images of the electronic component; processing at least some of those X-ray images to provide a 3D tomosynthesis image of the electronic component; analysing the obtained images to ascertain criteria relating to the electronic component; comparing the ascertained criteria against a set of known criteria to provide information as to the authenticity of the electronic component.

13. The method of claim 12, wherein the analysis of the images includes comparing an x-ray image taken at one height through the component with that of an x-ray image taken at another height through the component.

14. The method of claim 12, wherein the analysis of the images includes comparing the focus of a first portion of an x-ray image taken at one height through the component with that of a second portion of the x-ray image.

15. The method of claim 12, wherein the analysis of the images determines dimensions of the electronic component.

16. The method of claim 12, wherein the analysis compares the obtained infrared and/or ultraviolet images with visible spectrum images thus ascertaining the presence of oxides on electrical connectors in the electronic component.

17. The method of claim 12, wherein the analysis provides optical character recognition of the obtained images in the visible spectrum thus providing data equivalent to any text located on the electronic component, and wherein the method further comprises the step of processing the data and determining the authenticity of the electronic component.

18. The method of claim 12, comprising the step of comparing the images obtained at various spectra of one electrical component with those obtained at various spectra from another electrical component for use in authenticating either electronic component.

19. The method of claim 12, comprising the step of obtaining the reflectivity of the component in various spectra, such as infrared and/or ultraviolet for authenticating either electronic component.

20. The method of claim 12, comprising the step of analysing the obtained images to investigate a cavity formed in the electrical component for use in authenticating the electronic component.

21. The method of claim 12, comprising the step of analysing the obtained images of the electrical component and determining the presence, or otherwise, of lead for use in authenticating the electronic component.
